(19) United States
(12) Patent Application Publication
(10) Pub. No.: US 2016/0115560 A1
(43) Pub. Date: Apr. 28, 2016

(54) METHODS OF SEPARATING COMPONENTS USING MULTI-SCALE SIMULATED MOVING BED CHROMATOGRAPHY

(71) Applicant: Amalgamated Research LLC, Twin Falls, ID (US)

(72) Inventors: Michael M. Kearney, Twin Falls, ID (US); William A. Jacob, IV, Jerome, ID (US); Lawrence Velasquez, Twin Falls, ID (US)

(21) Appl. No.: 14/522,307

(22) Filed: Oct. 23, 2014

(51) Int. Cl. C13B 20/12; B01D 15/18

(52) U.S. Cl. CPC C13B 20/12; B01D 15/1828

(57) ABSTRACT

Described is a method of separating a product from a feed stream. The method comprises introducing a feed stream comprising a product and at least one other component to a simulated moving bed system. At least two scaling factors are applied to at least one of an inlet flow and an outlet flow to determine a temporal pattern for control of the flow(s). The product is separated from the at least one other component of the feed stream.

### TECHNICAL FIELD

Embodiments of the disclosure relate generally to methods of separating components of a multicomponent mixture by simulated moving bed (SMB) chromatography. More particularly, embodiments of the disclosure relate to separating the components of the multi component mixture by applying two or more scaling factors to at least one of an inlet flow and an outlet flow of a SMB chromatography system to determine a temporal pattern for control of the flow(s).

### BACKGROUND

A conventional SMB system includes several compartments (e.g., individual columns, individual beds) filled with a sorbent, such as a resin. A fluid conduit interconnects upstream and downstream ends of the system to form a loop through which a feed material having components to be separated is continuously recirculated. The constant flow of the feed material through the loop is called “internal recirculation flow.” A manifold system of tubing and valves is configured to position an inlet for the feed material, an inlet for desorbent (eluent), an outlet for a sorbed component and an outlet for a nonsorbed (or less sorbed) component. Each inlet and outlet communicates with a separate compartment; in some cases, separate compartments may be configured with multiple inlets and outlets along the flow loop. The feed material enters a designated compartment of the system and flows through the sorbent in the designated compartment by the continuous internal recirculation flow. This moving contact between the feed material and the sorbent in the compartments results in chromatographic separation of the components of the feed material. Sorbed components flowing at a relatively slow rate are removed from the sorbed component outlet. Nonsorbed components which flow at a relatively fast rate are removed from the nonsorbed component outlet. Desorbent is added at its inlet valve between the respective outlet valve positions of the sorbed and nonsorbed components. The order of component elution and efficiency of separation may be dependent on several factors including choice of sorbent, eluent, and feed material characteristics.

At predetermined time intervals (e.g., step time) the designated inlet and outlet valve positions in an SMB system are displaced downstream one position on the manifold to the next compartment, which may be a discrete section of a vessel, (such as a column), or an individual column. The step time is chosen such that the designation of valves is properly synchronized with the internal recirculation flow. Under these conditions, the SMB system reaches a steady state with specific product characteristics appearing at predetermined intervals in sequence at each valve position. This type of SMB system simulates valves held in a single position while the sorbent moves at a constant and continuous rate around the flow loop, producing constant quality product at each valve.

SMB chromatography utilizes less chromatography media and eluent than batch chromatography, which are important characteristics for implementation of chromatography at industrial scale. SMB chromatography also results in high operating capacity, high yields, high product purities and high product concentrations.

SMB chromatography may be operated in a continuous or sequential manner. In continuous simulated moving bed chromatography, all flows (e.g., inlet flows, outlet flows) are continuous. These flows include: feeding of feed material and eluent liquid, recycling of liquid mixture, and recovery of products. The flow rate of each flow may be adjusted in accordance with the separation goals (e.g., yield, purity, capacity) of the feed material. The feed material and product recovery points shift cyclically in the downstream direction. Inlet points for the feed material and eluent liquid and recovery (e.g., outlet) points for product or products are shifted gradually at substantially the same rate at which the components of the feed material move in the bed.

In sequential SMB chromatography, not all flows are continuous. These methods include three basic phases: feeding, eluting, and recycling. During the feed phase, a feed material and possibly also eluent liquid is fed into predetermined partial packing material beds, and product fractions are simultaneously recovered. During the eluting phase, eluent liquid is fed into a predetermined partial packing material bed, and during these phases, product fractions are recovered in addition to residue fractions. During the recycling phase, no feed material or eluent liquid is fed into the partial packing material beds and no products are recovered.

Intermittent simulated moving bed (“ISMB”) chromatography is accomplished as two phase repeating processes. During the first phase, the inlet flows and outlet flows are distributed along the unit as an SMB eluent, followed by extract, feed, and raffinate, but without any flow in the final section and consequently no fluid recycle to the first section. During the second phase, all inlet flows and outlet flows to the unit are closed and the recycle from the final section is established to the first section. After these two phases, all the inlet flows and outlet flows are shifted by one column bed in the direction of the fluid flow and the process is restarted from the first phase. This process and modifications thereof has the ability to achieve similar performance to conventional SMB chromatography, but with reduction of the number of columns per section in the ISMB chromatography.

U.S. Pat. No. 5,102,553 to Kearney et al., the disclosure of which is hereby incorporated herein in its entirety by this reference, describes control of individual flow rates in an SMB system in a time variable manner. In time variable simulated moving bed (TVSMB) chromatography, the flow rates through individual compartments are controlled to modify the specific steady state waveform characteristics of the process. This control is accomplished by varying any combination of the recirculation, inlet (feed material, solvent), or outlet (raffinate, extract) flow rates in a non-constant manner as a function of time during a step. Thus, productivity may be enhanced relative to that of SMB chromatography at constant flow rates, which is referred to herein as conventional SMB chromatography.

### BRIEF SUMMARY

Disclosed is a method of separating a product from a feed stream. The method comprises introducing a feed stream comprising a product and at least one other component to a simulated moving bed system. At least two scaling factors are applied to at least one of an inlet flow and an outlet flow of the simulated moving bed system to determine a temporal pattern for control of the flow(s). The product is separated from the at least one other component of the feed stream.

Also disclosed is a method of separating a product from a feed stream, the method comprising introducing a feed stream comprising a product and at least one other component to a simulated moving bed of a simulated moving bed system via an inlet flow. At least two scaling factors are applied to the inlet flow and the feed stream is flowed through other beds of the simulated moving bed system. The product is separated from the at least one other component of the feed stream.

### BRIEF DESCRIPTION OF THE DRAWINGS

FIGS. 1 and 2 are schematic representations of scaling factor determinations according to embodiments of the disclosure.

FIG. 3 is a simplified illustration of a configuration of an SMB system utilized in Example 1.

### DETAILED DESCRIPTION

A multi-scale approach to SMB chromatography is disclosed in which scaling factors are applied to at least one of an inlet flow and outlet flow of an SMB system. The scaling factors impact at least one of the flows entering (the inlet flow) and exiting (the outlet flow) the SMB system. Use of multi-scale SMB chromatography increases the efficiency of separating a desired product from a multicomponent mixture, such as a feed stream, as well as increasing the purity and yield of the desired product. The scaling factors may be iteratively applied to at least one of an inlet flow and outlet flow of an SMB system.

As used herein, the term “multi-scale simulated moving bed chromatography” refers to a chromatographic process where at least one of the inlet flow and the outlet flow of the SMB system is actuated between an “on” state and an “off” state while internal recirculation continues (the fluid stream flows through a bed and into the top of a subsequent bed) in the SMB system. While SMB systems having intermittent flows are known in the art, these SMB systems do not utilize scaling factors that actuate the inlet flow and the outlet flow between the on and off states while maintaining all other flows continuously.

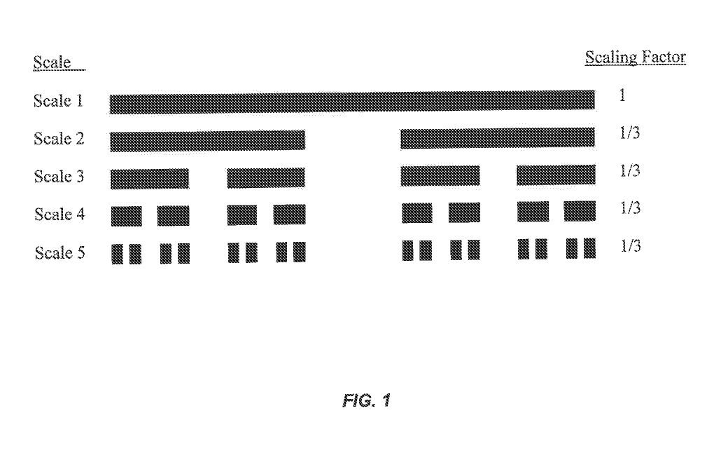

As used herein, the term “scaling factor” refers to a real number between 0 and 1 and that is utilized to determine a pattern of operation of the SMB system according to embodiments of the disclosure. The pattern of operation actuates at least one of the inlet flow and outlet flow between the on state and the off state. The scaling factor operates mathematically and is derived from an initial scale or a scale that precedes it, as discussed in more detail below in regard to FIG. 1.

The multi-scale approach of the disclosure may be used with a variety of SMB chromatography processes. Examples include SMB processes where the inlet and outlet flow rates are continuous or may follow time variable functions or steps are not identical with respect to function. In some embodiments, a feed stream containing a product to be separated along with other components may be introduced to the SMB system that includes a simulated moving bed filled with a chromatographic medium, such as an ion exchange resin. The SMB system typically includes one or more compartments (beds) containing the chromatographic medium. The simulated moving bed system may also include feed tanks, filters, tubing connecting flow between columns, beds and/or compartments where so connected, pumps, valves, pressure regulators, metering equipment, flow control equipment, and microprocessor equipment, which are well known in the art and are not described in detail herein. To accomplish the multi-scale SMB chromatography, the scaling factors may be incorporated into the operation and control of the SMB system. The microprocessor equipment may be programmed by conventional techniques to appropriately control the opening and closing of valves, flow rates of the inlet and outlet streams, and pressures within the SMB system.

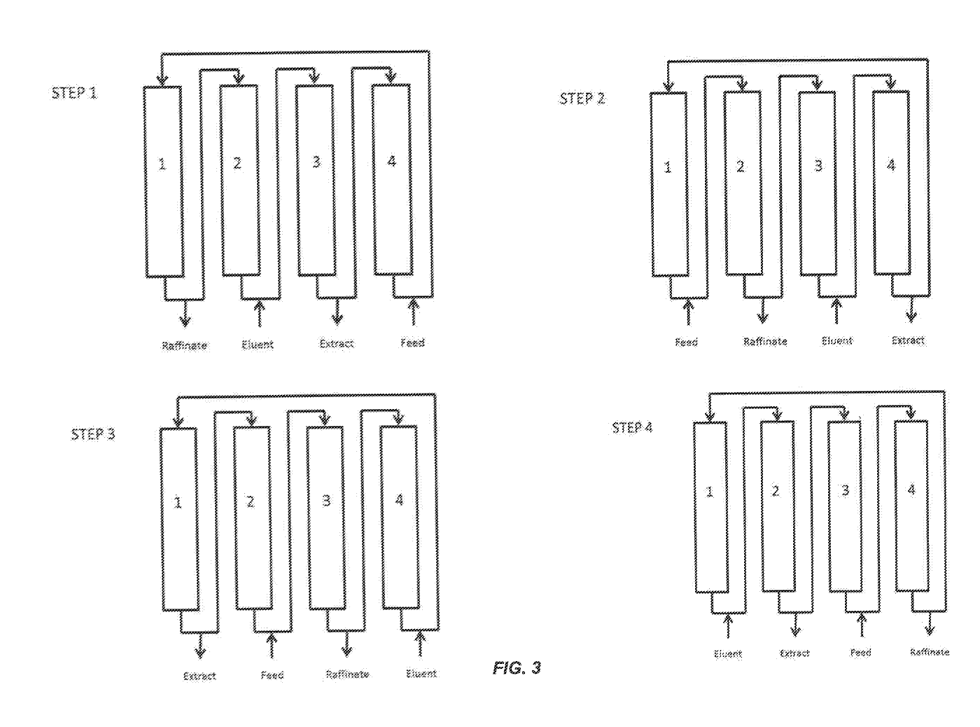

The operation of an embodiment of a SMB system including four beds is shown in FIG. 3. However, it is understood that greater than or less than four beds may be present in the SMB system. The individual beds are sequentially numbered 1 through 4 in the direction of flow. The beds are interconnected to form a recirculation loop where the flow returns to bed 1 after exiting bed 4. Inlet (e.g., feed stream, eluent) and outlet (raffinate, extract) valves are positioned along the recirculation loop at locations of each bed in the recirculation loop. In use and operation, the function of the inlets and outlets (the valve positions) is displaced one position downstream to commence Step 2 after a step time has elapsed in Step 1. In subsequent steps, valve positions are displaced downstream one position for each step, returning to Step 1 to restart the process. Those of ordinary skill in the art, after reading this disclosure, will appreciate multiple alternative arrangements of such steps to optimize the disclosed process for particular needs and feed streams.

While all flows in or out of the SMB system (feed, eluent, extract, raffinate) are continuously switched “on” over the cycle of all steps in the conventional SMB process, in the multi-scale SMB of the disclosure, the flow as a function of time may be determined by iterations of the scaling factors. FIG. 1 schematically represents temporally scaled flows according to one embodiment of the disclosure. In the mathematical literature, this is known as a Cantor set. The Cantor set is created by removing a middle portion from an initial line segment to form another line segment having segments of equal lengths. A middle portion is removed from the equal length segments of the resultant line segment to form yet another line segment having equal length segments. For example, and as shown in Scale 2 of FIG. 1, a middle one-third portion of the line segment (the initial line segment) of Scale 1 is removed, leaving two line segments. Next, the middle one-third portion of each of the line segments in Scale 2 is removed, leaving four line segments as shown in Scale 3 of FIG. 1. The pattern of line segments in Scales 4 and 5 are formed in a similar manner. While a five scale example of this process is illustrated in FIG. 1, this process may be continued ad infinitum. Additionally, while FIG. 1 illustrates a scaling factor of ⅓, other scaling factors may be used, such as ½, ¼, ⅕, etc.

The schematic illustration in FIG. 1 illustrates the multi-scale characteristic of the disclosed method by displaying both the scaling factors and the temporal distribution of flows. Each of the line segments in FIG. 1 represent the periods of time during which a particular inlet or outlet flow (feed, eluent, raffinate, extract) may be turned on by operation of the appropriate valves and pumps in the system. The black line segments schematically represent when the flow is in the “on” state, while the gaps between the black line segments schematically represent when the flow is in the “off” state as a function of time. Conventional SMB is represented by Scale 1 of FIG. 1 as a continuous black line segment, indicating that the flow is in a continuously “on” state, in contrast, the inlet or outlet flows during the multi-scale SMB chromatography may be on or off, as a function of time, along the path length of the bed according to the parameters of any one of Scales 2-5. The scaling factors that correspond to the on and off states of the flows may be selected as necessary to achieve the desired separation characteristics for the feed stream. The mathematical expression of the scaling factors may be derived from theoretical and/or empirical considerations, and it may be determined through experience with a particular feed stream.

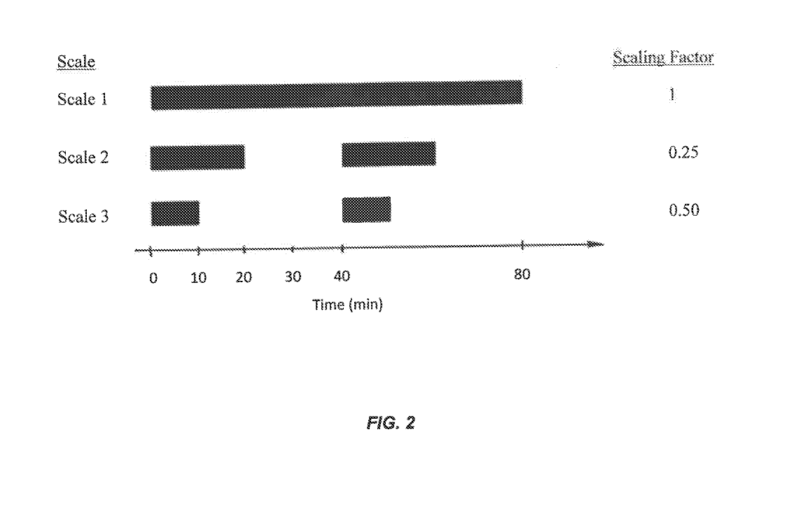

As illustrated in FIG. 1, the scaling factor between the different scales is constant, such as at ⅓. However, the scaling factors may vary between scales, and may be any multiplication factor to realize the desired separation of the product. Thus, while FIG. 1 illustrates a constant scaling factor of one-third, variable scaling factors may be used, as illustrated in FIG. 2, wherein the first scaling factor is one-fourth, and the second scaling factor is one-half. The different scaling factors illustrated in FIG. 2 may be applied to at least one of the inlet flow and the outlet flow of the SMB chromatographic system. Thus, a different scaling factor may be applied to each of the at least one of the inlet flow and the outlet flow.

The scaling factors may be applied to at least one of the inlet and outlet (feed, eluent, raffinate, extract) flows in the SMB system. Further, as the multi-scale SMB method may be used with any SMB systems, the multi-scale SMB chromatography may be utilized as an additional degree of control freedom in conjunction with other control methods such as continuous SMB, time variable SMB, or coupled loop SMB. For example, while a given flow rate may vary as a function of time while the flow is “on” in a TVSMB process, the flow rate may be turned on and off by the multi-scale SMB process of the disclosure. Further, two or more separate flows may be individually and simultaneously controlled by the multi-scale SMB process of the disclosure and another compatible method. If desired, the multi-scale SMB process of this disclosure may also be configured as a succession of chromatographic or other separations. For example, the product obtained from an initial SMB system operating in the manner of this disclosure may be used as a feed stream to a subsequent SMB system or batch chromatographic operation, or combination.

In certain embodiments, the multi-scale SMB chromatography may be utilized to separate the desired product from a variety of different types of feed streams. Such feed streams may include, but are not limited to, a sweetener mixture, an inorganic mixture, a pharmaceutical mixture, or a biomass-derived mixture. The sweetener mixture may include, but is not limited to, molasses, corn syrup, a sucrose solution, or a monosaccharide mixture. The inorganic mixture may include, but is not limited to, a mixture of metals and acids.

The following Examples are given to illustrate embodiments of the disclosure in more detail. The Examples are not to be construed as being exhaustive or exclusive as to the scope hereof. The Examples are given for illustrative purposes.

### EXAMPLES

### Example I

A feed stream obtained from sugar beets and that contained sucrose was subjected to multi-scale SMB chromatography to separate the sucrose and non-sucrose components. The non-sucrose components included salts and high molecular weight compounds. The SMB system used to separate the sucrose and non-sucrose components was configured as described in FIG. 3 and included an SMB chromatographic separator including four beds. The SMB system was operated using continuous internal recirculation. Each of the SMB beds included Dowex-99, a strong cationic, gel-type resin in the potassium form with a particle size of 350 microns. The scaling factors of FIG. 2 (1, 0.25, and 0.5) were used to determine the temporal pattern at Scale 3. This pattern was applied to an inlet flow, which introduced the feed stream into the SMB system. All other flows of the SMB system were maintained as continuous SMB flows. In Scale 1, a total cycle time of 80 minutes is shown, and this total cycle time was maintained for Scales 2 and 3. The inlet flow was actuated according to the intervals in Scale 3. For example, and as shown in Scale 3, the inlet flow was turned on from 0 minutes to 10 minutes, off from 10 minutes to 40 minutes, on from 40 minutes to 50 minutes, and off from 50 minutes to 80 minutes. This flow cycle was then repeated until complete feed of the mixture was accomplished. All other flows in the SMB system were maintained as continuous SMB flows.

Table 1 and Table 2 show the product profiles obtained using conventional SMB operation (Scale 1) versus the multi-scale SMB chromatography of the disclosure. The purity, color, conductivity, and of the feed stream, extract (product), and raffinate streams were measured by conventional techniques, which are not described in detail herein,

TABLE 1
Stream Analysis Obtained by Conventional SMB (Scale 1):

| | | | | | | Yield |
|---|---|---|---|---|---|---|
| | | | | conduc- | | (after |
| | | Color | % color | tivity | | crystalli- |
| Stream | Purity | (ICUMSA) | removal | mS | pH | zation) |
| Feed stream | 64 | 47500 | | | 8.7 | |
| Extract (product) | 86 | 6600 | 91 | 9.3 | 9.5 | 72.4% |
| Raffinate | 9.5 | 165000 | | | 7.1 | |

TABLE 2
Stream Analysis Obtained by Multi-scale SMB (Scale 3):

| | | | | | | Yield |
|---|---|---|---|---|---|---|
| | | | | conduc- | | (after |
| | | Color | % color | tivity | | crystalli- |
| Stream | Purity | (ICUMSA) | removal | mS | pH | zation) |
| Feed stream | 64 | 47500 | | | 8.7 | |
| Extract (product) | 97 | 2100 | 97 | 0.6 | 8.9 | 87.1% |
| Raffinate | 13.9 | 122303 | | | 8.3 | |

The purity of the product (sucrose) obtained with the multi-scale SMB chromatography was significantly higher than that obtained using the conventional SMB operation. The color of the product obtained using the multi-scale SMB chromatography was also significantly reduced, indicating that colored compounds are well eliminated with the multi-scale SMB chromatography. Further, the conductivity of the product was also very low, indicating high elimination of charged compounds, such as salts. The extract in the above example will typically be subjected to a subsequent crystallization step to recover the sucrose as a final saleable product. Therefore, the recovery (yield) of the product sucrose must be determined by combining the chromatography and the crystallization steps. Using this reference basis, the product yield for the conventional SMB operation in Table 1=72.4% while the product yield for the multiscale operation in Table 2 is 87.1%.

What is claimed is:

1. A method of separating a product from a feed stream, the method comprising:
introducing a feed stream comprising a product and at least one other component to a simulated moving bed system;
applying at least two scaling factors to at least one of an inlet flow and an outlet flow of the simulated moving bed system;
flowing the feed stream through the simulated moving bed system; and
separating the product from the at least one other component of the feed stream.

2. The method according to claim 1, wherein applying the at least two scaling factors to at least one of an inlet flow and an outlet flow of the simulated moving bed system comprises actuating the at least one of the inlet flow and the outlet flow at an interval specified by the at least two scaling factors.

3. The method according to claim 1, wherein applying the at least two scaling factors to at least one of an inlet flow and an outlet flow of the simulated moving bed system comprises applying the at least two scaling factors to at least one of the feed stream, an eluent stream, a raffinate stream, and an extract stream flowing through the simulated moving bed system.

4. The method according to claim 1, wherein separating the product from the at least one other component of the feed stream comprises producing an extract stream comprising the product, wherein the extract stream comprises a higher concentration of the product than the feed stream and a lower concentration of the at least one other component than the feed stream.

5. The method according to claim 1, wherein introducing the feed stream comprising a product and at least one other component to a simulated moving bed system comprises introducing a feed solution comprising a sweetener containing mixture, an inorganic mixture, a biomass derived mixture, or a pharmaceutical mixture to the simulated moving bed system.

6. The method according to claim 1, wherein flowing the feed stream through the simulated moving bed system comprises flowing the feed stream in a continuous internal recirculation through the simulated moving bed system.

7. The method according to claim 1, wherein introducing the feed stream comprising a product and at least one other component to a simulated moving bed system comprises introducing the feed stream to a simulated moving bed (SMB) system selected from the group consisting of continuous SMB, semi-continuous SMB, time variable SMB, and coupled loop SMB.

8. The method according to claim 1, wherein applying the at least two scaling factors to at least one of an inlet flow and an outlet flow of the simulated moving bed system comprises applying a constant scaling factor to the at least one of the inlet flow and the outlet flow of the simulated moving bed system.

9. The method according to claim 1, wherein applying the at least two scaling factors to at least one of an inlet flow and an outlet flow of the simulated moving bed system comprises applying a different scaling factor to each of the at least one of the inlet flow and the outlet flow of the simulated moving bed system.

10. The method according to claim 1, wherein applying the at least two scaling factors to at least one of an inlet flow and an outlet flow of the simulated moving bed system comprises applying the at least two scaling factors to the flow of the feed stream.

11. The method according to claim 1, wherein applying the at least two scaling factors to at least one of an inlet flow and an outlet flow of the simulated moving bed system comprises iteratively applying at least three scaling factors to the at least one of an inlet flow and an outlet flow.

12. The method according to claim 1, further comprising:
recovering the product.

13. A method of separating a product from a feed stream, the method comprising:
introducing a feed stream comprising a product and at least one other component to a simulated moving bed of a simulated moving bed system via an inlet flow;
applying at least two scaling factors to the inlet flow;
flowing the feed stream through other beds of the simulated moving bed system; and
separating the product from the at least one other component of the feed stream.

14. The method according to claim 12, wherein applying the at beast two scaling factors to the inlet flow comprises actuating the inlet flow at an interval specified by the at least two scaling factors while maintaining continuous internal recirculation through the simulated moving bed system.

15. The method according to claim 12, wherein introducing the feed stream comprising a product and at least one other component to a simulated moving bed of the simulated moving bed system via an inlet flow comprises introducing a feed stream comprising sucrose and non-sucrose components.

16. The method of claim 14, further comprising:
recovering the sucrose.
